(19) United States
(12) Patent Application Publication
(10) Pub. No.: US 2026/0113828 A1
(43) Pub. Date: Apr. 23, 2026

(54) SELECTING AND RENDERING A TRANSITION BETWEEN LIGHT SCENES BASED ON LIGHTING DEVICE ORIENTATION AND/OR SHAPE

(71) Applicant: SIGNIFY HOLDING B.V., EINDHOVEN (NL)

(72) Inventor: GERHARDUS ENGBERTUS MEKENKAMP, VALKENSWAARD (NL)

(21) Appl. No.: 18/704,105

(22) PCT Filed: Oct. 19, 2022
(86) PCT No.: PCT/EP2022/079027

§ 371 Date: Apr. 24, 2024

(30) Foreign Application Priority Data
Oct. 25, 2021 (EP) 21204475.4

(51) Int. Cl. H05B 47/175; H05B 47/19

(52) U.S. Cl. CPC H05B 47/196; H05B 47/19

(57) ABSTRACT

A system for controlling a plurality of individually controllable light segments (12-18) of a pixelated lighting device to render a first light scene (71-77) and subsequently a second light scene (81-87) is configured to obtain data indicative of an orientation and/or a shape of the pixelated lighting device, control the light segments to render the first light scene, receive input indicative of activation of the second light scene, select a type of transition based on the orientation and/or the shape, determine a transition from the first light scene to the second light scene based on the selected type of transition, control the light segments to render the transition, and control the light segments to render the second light scene. A first type of transition is selected for a first orientation or a first shape and a second type of transition is selected for a second orientation or a second shape.

### FIELD OF THE INVENTION

The invention relates to a system for controlling a plurality of individually controllable light segments of a pixelated lighting device to render a first light scene and subsequently a second light scene.

The invention further relates to a method of controlling a plurality of individually controllable light segments of a pixelated lighting device to render a first light scene and subsequently a second light scene.

The invention also relates to a computer program product enabling a computer system to perform such a method.

### BACKGROUND OF THE INVENTION

Pixelated lighting devices, i.e. lighting devices with multiple individually controllable light segments, are becoming more readily available. For example, Signify is selling light strips with individually addressable LEDs. Depending on the size of the luminaire, the number of individually addressable LEDs typically ranges from 4 to 16. These pixelated lighting devices may be used to render entertainment light effects to accompany audio and/or video content, but also make it possible to render nice gradient effects.

An example of a lighting device generating a dynamic light setting based on its orientation is disclosed in US2018/0153023 A1. A lighting device is disclosed, which can generate a first light setting based on the orientation of a lighting device and a second light setting when a reorientation of the lighting device is detected.

US 2019/0335560 A1 discloses a lighting device which comprises an array of controllable light emitting pixels, each pixel having an adjustable light output color, and can render color gradients on these pixels. In an embodiment, these color gradients are dynamic. Although US 2019/0335560 A1 discloses transitions between colors of neighboring pixels, it does not disclose the use of transitions between colors of the same pixel, not even within the same dynamic gradient.

Transitions between colors of the same pixel have implemented on single-pixel lighting devices, e.g. Hue color bulbs. For example, when a new light scene is selected for a color bulb, the bulb may transition through the color space until it reaches the color of the new light scene. That way, the lamp transitions to a new color instead of just instantly showing the new color. Unfortunately, such transitions have not been implemented on pixelated lighting devices, likely because they are more difficult to implement on pixelated lighting devices. With pixelated lighting devices, a new gradient or color pattern is suddenly set when a new light scene is selected and this does not create a good user experience.

### SUMMARY OF THE INVENTION

It is a first object of the invention to provide a system, which controls light segments of a pixelated lighting device to render a suitable transition from a first light scene to a second light scene.

It is a second object of the invention to provide a method which can be used to control light segments of a pixelated lighting device to render a suitable transition from a first light scene to a second light scene.

In a first aspect of the invention, a system for controlling a plurality of individually controllable light segments of a pixelated lighting device to render a first light scene and subsequently a second light scene comprises at least one input interface, at least one control interface, and at least one processor configured to obtain data indicative of an orientation and/or a shape of said pixelated lighting device, control, via said at least one control interface, said plurality of individually controllable light segments to render said first light scene, and receive, via said at least one input interface, input indicative of activation of said second light scene.

Said at least one processor is further configured to select a type of transition based on said orientation and/or said shape, a first type of transition being selected for a first orientation or a first shape and a second type of transition being selected for a second orientation or a second shape, determine a transition from said first light scene to said second light scene based on said selected type of transition, control, via said at least one control interface, said plurality of individually controllable light segments to render said transition, and control, via said at least one control interface, said plurality of individually controllable light segments to render said second light scene.

This system determines a transition from a first light scene to a second light scene for a pixelated lighting device, and more specifically, it selects a suitable transition type based on the orientation and/or the shape of the pixelated lighting device and determines the transition based this transition type. The use of a transition between light scenes already improves the user experience, but by selecting a suitable transition type from a plurality of transition types based on the orientation and/or the shape, an even better user experience is achieved.

The system and the pixelated lighting device may be the same device or the system may be a component of the pixelated lighting device, for example. Said input may be user input. Said first shape may be a circle and said second shape may be a line, for example. Said first transition and said second transition may be different spatial transitions. These different spatial transitions are preferably transitions in different directions. Said first light scene and said second light scene may define color and/or brightness gradients. Gradients may be calculated based two or three colors, but it is also possible to calculate gradients based on more colors. Alternatively, said first light scene and/or said second light scene may define a (non-gradient) color and/or brightness pattern. For example, said first light scene may represent multiple candles. In this case, one or more of said transition types may visualize said candles being extinguished. Said second light scene is normally independent of said first light scene.

In at least a first example of a transition type, light settings from said first light scene may be shifted towards a first side of said pixelated lighting device and light settings from said second light scene may be moved in at a second side of said pixelated lighting device.

In a second example of a transition type, light settings from said first light scene may be shifted towards sides of said pixelated lighting device and light settings from said second light scene may be moved in at a center of said pixelated lighting device.

In a third example of a transition type, light settings from said first light scene may be shifted towards a center of said pixelated lighting device and light settings from said second light scene may be moved in at sides of said pixelated lighting device.

Said at least one processor may be configured to select said type of transition based on said orientation of said pixelated lighting device and based on a desired spatial transition direction or an orientation of a further pixelated lighting device. This makes it possible to select the transition type such that multiple pixelated lighting devices in a room transition in the same way. For example, when a user has mounted multiple light strips horizontally, the orientations of the strips may differ depending on the location of the closest power socket. A desired spatial transition direction, e.g. left-to-right, right-to-left, or symmetric, may be configured in the system, e.g. by the manufacturer or by a user. A spatial transition direction setting of individual pixelated lighting devices may be overridden.

Said at least one processor may be configured to select said type of transition further based on a position of said pixelated lighting device. For example, if said orientation of said pixelated lighting device is vertical, a transition which comprises moving out light settings from said first light scene at a side of said pixelated lighting device which is farthest from a wall or floor and moving in light settings from said second light scene at a side of said pixelated lighting device which is closest to said wall or floor may be considered most suitable and may therefore be selected. Said processor may be configured to determine said side farthest from the wall or floor and said side closest to the wall or floor based on the position.

Said at least one processor may be configured to select said type of transition further based on a user preference. If multiple transition types are suitable for a certain orientation and/or shape of the pixelated lighting device, the user preference may be used to select from these multiple transition types.

In a second aspect of the invention, a method of controlling a plurality of individually controllable light segments of a pixelated lighting device to render a first light scene and subsequently a second light scene comprises obtaining data indicative of an orientation and/or a shape of said pixelated lighting device, controlling said plurality of individually controllable light segments to render said first light scene, and receiving input indicative of activation of said second light scene.

The method further comprises selecting a type of transition based on said orientation and/or said shape, a first type of transition being selected for a first orientation or a first shape and a second type of transition being selected for a second orientation or a second shape, determining a transition from said first light scene to said second light scene based on said selected type of transition, controlling said plurality of individually controllable light segments to render said transition, and controlling said plurality of individually controllable light segments to render said second light scene. Said method may be performed by software running on a programmable device. This software may be provided as a computer program product.

Moreover, a computer program for carrying out the methods described herein, as well as a non-transitory computer readable storage-medium storing the computer program are provided. A computer program may, for example, be downloaded by or uploaded to an existing device or be stored upon manufacturing of these systems.

A non-transitory computer-readable storage medium stores at least one software code portion, the software code portion, when executed or processed by a computer, being configured to perform executable operations for controlling a plurality of individually controllable light segments of a pixelated lighting device to render a first light scene and subsequently a second light scene.

The executable operations comprise obtaining data indicative of an orientation and/or a shape of said pixelated lighting device, controlling said plurality of individually controllable light segments to render said first light scene, receiving input indicative of activation of said second light scene, selecting a type of transition based on said orientation and/or said shape, a first type of transition being selected for a first orientation or a first shape and a second type of transition being selected for a second orientation or a second shape, determining a transition from said first light scene to said second light scene based on said selected type of transition, controlling said plurality of individually controllable light segments to render said transition, and controlling said plurality of individually controllable light segments to render said second light scene.

As will be appreciated by one skilled in the art, aspects of the present invention may be embodied as a device, a method or a computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit”, “module” or “system.” Functions described in this disclosure may be implemented as an algorithm executed by a processor/microprocessor of a computer. Furthermore, aspects of the present invention may take the form of a computer program product embodied in one or more computer readable medium(s) having computer readable program code embodied, e.g., stored, thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples of a computer readable storage medium may include, but are not limited to, the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of the present invention, a computer readable storage medium may be any tangible medium that can contain, or store, a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber, cable, RF, etc., or any suitable combination of the foregoing. Computer program code for carrying out operations for aspects of the present invention may be written in any combination of one or more programming languages, including an object oriented programming language such as Java™, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems), and computer program products according to embodiments of the present invention. It will be understood that each block of the flowchart illustrations and/or block diagrams, and combinations of blocks in the flowchart illustrations and/or block diagrams, can be implemented by computer program instructions. These computer program instructions may be provided to a processor, in particular a microprocessor or a central processing unit (CPU), of a general purpose computer, special purpose computer, or other programmable data processing apparatus to produce a machine, such that the instructions, which execute via the processor of the computer, other programmable data processing apparatus, or other devices create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of devices, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

### BRIEF DESCRIPTION OF THE DRAWINGS

These and other aspects of the invention are apparent from and will be further elucidated, by way of example, with reference to the drawings, in which:

FIG. 1 is a block diagram of a first embodiment of the system;

FIG. 2 depicts a pixelated lighting device with a circle shape;

FIG. 3 is a block diagram of a second embodiment of the system;

FIG. 4 is a flow diagram of a first embodiment of the method;

FIG. 5 is a flow diagram of a second embodiment of the method;

FIGS. 6-8 show examples of transitions between light scenes;

FIG. 9 is a flow diagram of a third embodiment of the method;

FIG. 10 is a flow diagram of a fourth embodiment of the method; and

FIG. 11 is a block diagram of an exemplary data processing system for performing the method of the invention.

Corresponding elements in the drawings are denoted by the same reference numeral.

### DETAILED DESCRIPTION OF THE EMBODIMENTS

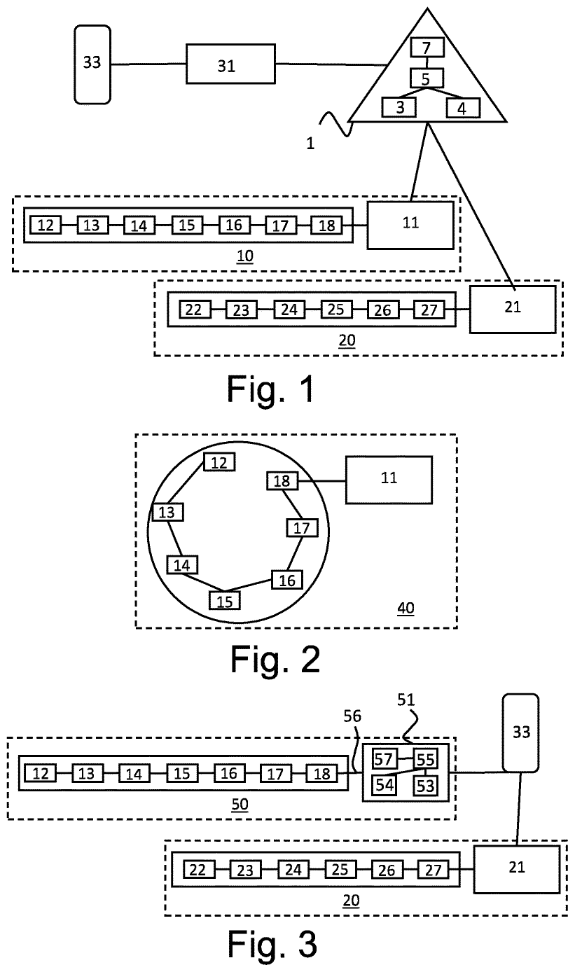

FIG. 1 shows a first embodiment of the system for controlling a plurality of individually controllable light segments of a pixelated lighting device to render a first light scene and subsequently a second light scene. In this first embodiment, the system is a bridge 1. FIG. 1 depicts two pixelated lighting devices: light strips 10 and 20. Light strips 10 and 20 comprise controllers 11 and 21, respectively. Light strip 10 comprises seven individually controllable light segments 12-18 and light strip 20 comprises six individually controllable light segments 22-27. Each individually controllable light segment comprises one or more light sources, e.g., LED elements.

The bridge 1 and the light strips 10 and 20 can communicate wirelessly, e.g., via Zigbee. The bridge 1 is connected to a wireless LAN access point 31, e.g., via Ethernet or Wi-Fi. A mobile phone 33 is also able to connect to the wireless LAN access point 31, e.g., via Wi-Fi. The mobile phone 33 can be used to control the light strips 10 and 20 via the wireless LAN access point 31 and the bridge 1, e g. to turn the light strips on or off or to change their light settings.

The bridge 1 comprises a receiver 3, a transmitter 4, a processor 5, and a memory 7. The processor 5 is configured to obtain data indicative of an orientation and/or a shape of the pixelated lighting device, control, via the transmitter 4, the individually controllable light segments 12-18 to render the first light scene, and receive, via the receiver 3, input indicative of activation of the second light scene. The input may be user input, for example. The input may be received from mobile device 33, for example.

Data indicative of the shape of light strip 10 may be obtained, for example, from light strip 10, which may store this information in its memory. Data indicative of the orientation of light strip 10 may be obtained, for example, from light strip 10, which may e.g. detect this information automatically using an orientation sensor and/or may store a flag which indicates at which side the power supply is located. Alternatively, data indicative of the shape and/or the orientation of light strip 10 may be obtained, for example, from mobile device 33, which may determine this information from an image captured by a camera.

The processor 5 is further configured to select a type of transition based on the orientation and/or the shape, determine a transition from the first light scene to the second light scene based on the selected type of transition, control, via the transmitter 4, the light segments 12-18 to render the transition, and control, via the transmitter 4, light segments 12-18 to render the second light scene. A first type of transition is selected for a first orientation or a first shape and a second type of transition is selected for a second orientation or a second shape.

The transition may be determined based on other parameters than just the transition type, e.g. specifics of the first light scene and/or second light scene. In this case, the transition is more than just the transition type. If it is not, the transition type may simply be specified in the light control command. This light control command may further include an identification of the second light scene or specify light settings of the second light scene.

In the embodiment of the bridge 1 shown in FIG. 1, the bridge 1 comprises one processor 5. In an alternative embodiment, the bridge 1 comprises multiple processors. The processor 5 of the bridge 1 may be a general-purpose processor, e.g., ARM-based, or an application-specific processor. The processor 5 of the bridge 1 may run a Unix-based operating system for example. The memory 7 may comprise one or more memory units. The memory 7 may comprise solid-state memory, for example. The memory 7 may be used to store a table of connected lights, for example.

The receiver 3 and the transmitter 4 may use one or more wired or wireless communication technologies, e.g., Ethernet for communicating with the wireless LAN access point 31 and Zigbee for communicating with the light strips 10 and 20, for example. In an alternative embodiment, multiple receivers and/or multiple transmitters are used instead of a single receiver and a single transmitter. In the embodiment shown in FIG. 1, a separate receiver and a separate transmitter are used. In an alternative embodiment, the receiver 3 and the transmitter 4 are combined into a transceiver. The bridge 1 may comprise other components typical for a network device such as a power connector. The invention may be implemented using a computer program running on one or more processors.

In the embodiment of FIG. 1, the pixelated lighting devices 10 and 20 are light strips. Light strips can normally be installed in a line shape and can sometimes be installed in a circle shape. Pixelated lighting devices may be also sold in a form in which they have a circle shape. FIG. 2 shows an example of such a pixelated lighting device, e.g. a bathroom mirror lamp. Pixelated lighting device 40 has light segments 12-18 positioned in a circle shape. Light segment 18 is connected to controller 11. For a circle-shaped pixelating lighting device, a transition from left-to-right or from right-to-left may not look very nice and blending in the new light scene per light segment (i.e. per pixel) may look nicer.

FIG. 3 shows a second embodiment of the system for controlling a plurality of individually controllable light segments of a pixelated lighting device to render a first light scene and subsequently a second light scene. In this second embodiment, the system is a pixelated lighting device 50. FIG. 3 also depicts the light strip 20 of FIG. 1. In the embodiment of FIG. 3, the mobile device 33 controls the pixelated lighting devices 20 and 50 directly, e.g., using Bluetooth.

The light strip 20 depicted in FIGS. 1 and 3 can be controlled either via a bridge (see FIG. 1), e.g., using Zigbee, or directly by a mobile device (see FIG. 3), e.g., using Bluetooth. In an alternative embodiment, a pixelated lighting device can only be controlled via a bridge or can only be controlled directly by a mobile or non-mobile device, e.g. via a wireless connection (e.g. Bluetooth) or a wired connection (e.g. USB).

The pixelated lighting device 50 comprises a controller 51, seven individually controllable light segments 12-18, and a control interface 56 between the controller 51 and light segments 12-18. The controller 51 comprises a transceiver 53, a transmitter 54, a processor 55, memory 57, and a touchscreen display 59. The processor 55 is configured to obtain data indicative of an orientation and/or a shape of the pixelated lighting device, e.g. from memory 57, control, via the control interface 56, the individually controllable light segments 12-18 to render the first light scene, and receive, via the receiver 53, input indicative of activation of the second light scene. The input may be user input, for example. The input may be received from mobile device 33, for example.

The processor 55 is further configured to select a type of transition based on the orientation and/or the shape, determine a transition from the first light scene to the second light scene based on the selected type of transition, control, via the control interface 56, the light segments 12-18 to render the transition, and control, via the control interface 56, light segments 12-18 to render the second light scene. A first type of transition is selected for a first orientation or a first shape and a second type of transition is selected for a second orientation or a second shape.

For example, the memory 57 may be a flash memory and light parameters may be stored in this flash memory. These parameters may include the number of pixels, the type of light or luminaire, the shape, and/or the orientation. When the lighting device 50 receives a command to move to a new light state, the lighting device 50 determines which transition profile/sequence to apply based on the original state the target state and the stored parameters.

For example, to move from a scene with a first gradient to a scene with a second gradient, a transition type may be selected which has the objective of reducing the number of transitional colors which were not present in the original gradients. Each pixel may transition individually from the original color to the target color, or only the specified gradient colors may transition from original to target color and the interpolated colors may be determined by calculating a gradient. Typically, a gradient light scene is defined by specifying three to five colors and the colors for the other pixels are interpolated.

In the embodiment of the pixelated lighting device 51 shown in FIG. 2, the pixelated lighting device 51 comprises one processor 55. In an alternative embodiment, the pixelated lighting device 1 comprises multiple processors. The processor 55 of the pixelated lighting device 1 may be a general-purpose processor or an application-specific processor. The memory 57 may comprise one or more memory units. The memory 57 may comprise solid state memory, for example.

The receiver 53 and the transmitter 54 may use one or more wireless communication technologies, e.g., Bluetooth, for communicating with the mobile device 33. In an alternative embodiment, multiple receivers and/or multiple transmitters are used instead of a single receiver and a single transmitter. In the embodiment shown in FIG. 3, a separate receiver and a separate transmitter are used. In an alternative embodiment, the receiver 53 and the transmitter 54 are combined into a transceiver. The pixelated lighting device 51 may comprise other components typical for a pixelated lighting device such as a battery and/or a power connector. The invention may be implemented using a computer program running on one or more processors.

In the embodiments of FIGS. 1 and 3, the system of the invention comprises a bridge or a pixelated lighting device. In an alternative embodiment, the system of the invention is a different device, e.g., a mobile device or a cloud computer. In the embodiments of FIGS. 1 and 3, the system of the invention comprises a single device. In an alternative embodiment, the system of the invention comprises a plurality of devices.

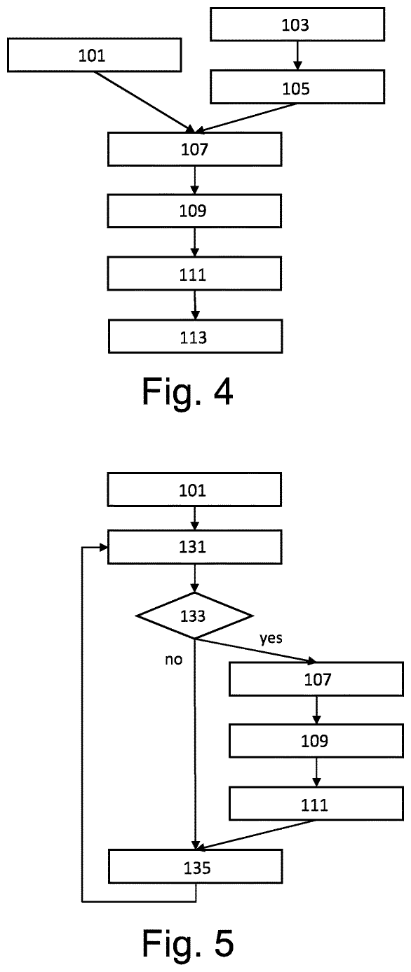

A first embodiment of the method of controlling a plurality of individually controllable light segments of a pixelated lighting device (e.g. light strip 10 of FIGS. 1 and 3) to render a first light scene and subsequently a second light scene is shown in FIG. 4. The second light scene is independent of the first light scene. The first light scene and the second light scene may define color and/or brightness gradients, for example. The method may be performed by the bridge 1 of FIG. 1 or the pixelated lighting device 50 of FIG. 3, for example.

A step 101 comprises obtaining data indicative of an orientation and/or a shape of the pixelated lighting device. A step 103 comprises controlling the plurality of individually controllable light segments to render the first light scene. A step 105 comprises receiving input indicative of activation of the second light scene. The input may be user input, for example. In the embodiment of FIG. 4, step 101 and steps 103 and 105 are performed at least partly in parallel. In an alternative embodiment, step 101 is performed before step 103 or after step 105.

A step 107 is performed after steps 101 and 105 have been performed. Step 107 comprises selecting a type of transition based on the orientation and/or the shape. In step 107, a first type of transition is selected if the orientation is a first orientation or the shape is a first shape and a second type of transition is selected if the orientation is a second orientation or the shape is a second shape.

A step 109 comprises determining a transition from the first light scene to the second light scene based on the type of transition selected in step 107. The transition may be determined based on other parameters than just the transition type, e.g. specifics of the first light scene and/or second light scene. Determining the transition may comprise determining a transition profile/sequence. Alternatively, a transition profile/sequence may later be determined based on the transition determined in step 109, e.g. by the pixelated lighting device. The transition profile/sequence typically comprises multiple steps. With regard to color, any step through white is preferably avoided. With regard to brightness, steps are preferably equal. Preferably, brightness is changed at a slower rate than color. The duration of the transition and the duration of the steps of the transition profile/sequence may depend on the color distance(s).

A step 111 comprises controlling the plurality of individually controllable light segments to render the transition determined in step 109. A step 113 comprises controlling the plurality of individually controllable light segments to render the second light scene.

A second embodiment of the method of controlling a plurality of individually controllable light segments of a pixelated lighting device to render a first light scene and subsequently a second light scene is shown in FIG. 5. The second light scene is independent of the first light scene. The first light scene and the second light scene may define color and/or brightness gradients, for example. The method may be performed by the bridge 1 of FIG. 1 or the pixelated lighting device 50 of FIG. 3, for example.

Step 101 comprising obtaining data indicative of an orientation and/or a shape of the pixelated lighting device. A step 131 comprises receiving input indicative of activation of a light scene. The input may be user input, for example. Next, a step 133 comprises determining whether the pixelated lighting device is already rendering a light scene. If so, step 107 is performed next. If not, steps 107, 109, and 111 are skipped and step 135 is performed next.

Step 107 comprises selecting a type of transition based on the orientation and/or the shape. In step 107, a first type of transition is selected if the orientation is a first orientation or the shape is a first shape and a second type of transition is selected if the orientation is a second orientation or the shape is a second shape. In step 107, the type of transition may further be selected based on a user preference.

Step 109 comprises determining a transition from the first light scene, i.e., the light scene currently being rendered, to the second light scene, i.e., the light scene whose activation was indicated in step 131, based on the type of transition selected in step 107. The transition may be determined based on other parameters than just the transition type, e.g. specifics of the first light scene and/or second light scene. Determining the transition may comprise determining a transition profile/sequence. Step 111 comprises controlling the plurality of individually controllable light segments to render the transition determined in step 109.

Step 135 comprises controlling the plurality of individually controllable light segments to render the light scene whose activation was indicated in step 131. If both step 111 and step 135 are performed, the same light control command may be used to control the light segments to render the transition and the light scene. Step 131 is repeated after step 135, after which the method proceeds as shown in FIG. 5.

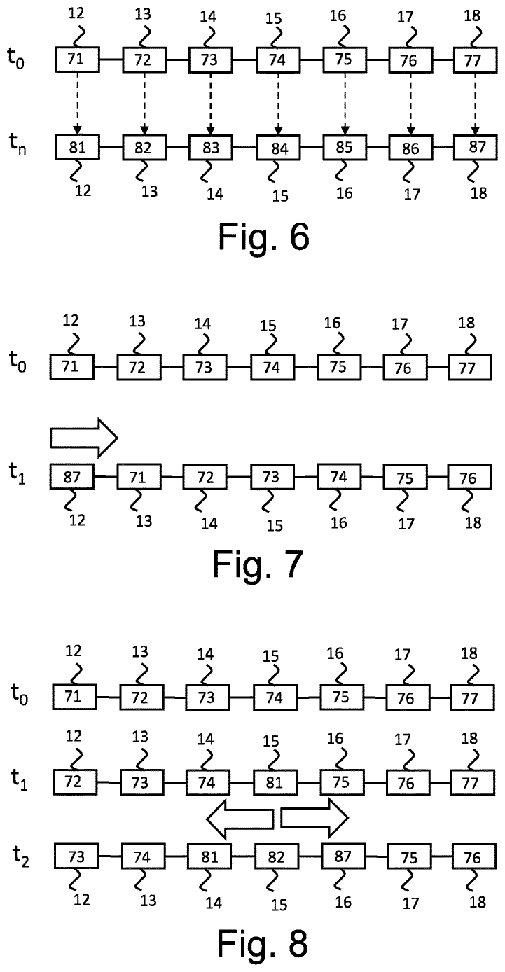

With multiple pixels which can be individually controlled, many types of transitions between light scenes may be defined. FIGS. 6-8 show examples of such transitions. In the examples of FIGS. 6-8, a first color gradient transitions to a second color gradient. The light scenes are rendered on individual controllable light segments 12-18. The first color gradient consists of colors 71-77. The second color gradient consists of colors 81-87.

FIG. 6 shows an example in which each pixel performs a color transition the same way as a light bulb. In this example, all pixels simultaneously move to their assigned color in the new gradient. In other words, the new light scene is blended in per light segment (i.e. per pixel). While transitioning (between time t₀ and time tₙ; n being larger than 1), different colors, possibly many different colors, are visible. These transitional colors may not have been present in the start or end gradient.

A totally different way of transitioning to a new gradient is shown in FIGS. 7 and 8. In these example, the first transition and the second transition are different spatial transitions. In the example of FIG. 7, light settings from the first light scene are shifted towards a first side of the pixelated lighting device and light settings from the second light scene are moved in at a second side of the pixelated lighting device.

In the example of FIG. 7, the existing gradient is shifted to the right, allowing the new gradient to come in from the left. At moment t₁, colors 71 to 76 of the first color gradient have been shifted right one position compared to moment t₀. Furthermore, at moment t₁, the last color 87 of the second color gradient is rendered by the leftmost light segment 12 and the last color 77 of the first color gradient is no longer rendered. In an alternative example, the existing gradient is shifted to the left, allowing the new gradient to come in from the right.

In the example of FIG. 8, light settings from the first light scene are shifted towards sides of the pixelated lighting device and light settings from the second light scene are moved in at a center of the pixelated lighting device. At moment t₁, colors 72 to 74 of the first color gradient have been shifted left one position compared to moment t₀. Furthermore, at moment t₀, the first color 81 of the second color gradient is rendered by the center light segment 15 and the first color 71 of the first color gradient is no longer rendered.

At moment t₂, colors 73 to 74 of the first color gradient and color 81 of the second color gradient have been shifted left one position compared to moment t₁ and colors 75 to 76 of the first color gradient have been shifted right one position compared to moment t₁ (and compared to moment t₀). Furthermore, at moment t₂, color 82 of the second color gradient moves in at light segment 15, the last color 87 of the second color gradient moves in at light segment 16, and colors 71, 72, and 77 of the first color gradient are no longer rendered.

In an alternative example, light settings from the first light scene are shifted towards a center of the pixelated lighting device and light settings from the second light scene are moved in at sides of the pixelated lighting device. In different situations, different transition types may be preferred. The preferred transition type may depend, for example, on the start and target colors, the on-off state of the light, the position and orientation of the light, as well as user preference.

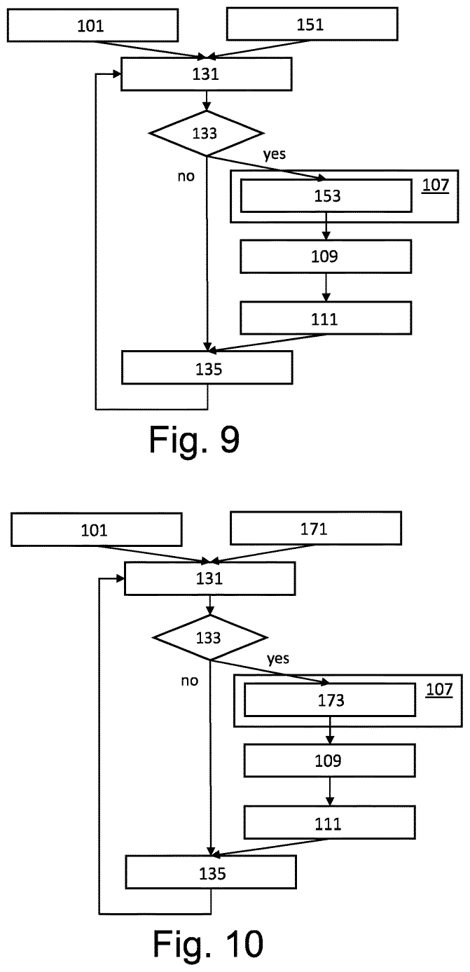

A third embodiment of the method of controlling a plurality of individually controllable light segments of a pixelated lighting device to render a first light scene and subsequently a second light scene is shown in FIG. 9. The third embodiment of FIG. 9 is an extension of the second embodiment of FIG. 5. In the embodiment of FIG. 9, a step 151 is performed before step 131 of FIG. 5 and step 107 of FIG. 5 is implemented by a step 153.

In the embodiment of FIG. 9, step 101 comprises determining at least the orientation of the pixelated lighting device and optionally the shape of the pixelated lighting device. Step 151 comprises determining a desired spatial transition direction or an orientation of a further pixelated lighting device (e.g. light strip 20 of FIGS. 1 and 3). In the embodiment of FIG. 9, step 101 and step 151 are performed at least partly in parallel. In an alternative embodiment, step 151 is performed before step 101 or after step 101.

Step 153 comprises selecting the type of transition based on the orientation of the pixelated lighting device, as determined in step 101, and based on the desired spatial transition direction or an orientation of a further pixelated lighting device, as determined in step 151. For example, when a user has mounted multiple light strips horizontally, the orientations of the strips may differ depending on the location of the closest power socket. A desired spatial transition direction, e.g. left-to-right, right-to-left, or symmetric, may be configured in the system, e.g. by the manufacturer or by a user. A spatial transition direction setting of individual pixelated lighting devices may be overridden.

A fourth embodiment of the method of controlling a plurality of individually controllable light segments of a pixelated lighting device to render a first light scene and subsequently a second light scene is shown in FIG. 10. The fourth embodiment of FIG. 10 is an extension of the second embodiment of FIG. 5. In the embodiment of FIG. 10, a step 171 is performed before step 131 of FIG. 5 and step 107 of FIG. 5 is implemented by a step 173.

Step 171 comprises determining a position of the pixelated lighting device. In the embodiment of FIG. 10, step 101 and step 171 are performed at least partly in parallel. In an alternative embodiment, step 171 is performed before step 101 or after step 101. Step 173 comprises selecting the type of transition based on the orientation and/or the shape of the pixelated lighting device, as determined in step 101, and further based on the position of the pixelated lighting device, as determined in step 171.

For example, if the orientation of the pixelated lighting device is vertical, the selected transition may comprise moving out light settings from the first light scene at a side of the pixelated lighting device which is farthest from a wall or floor and moving in light settings from the second light scene at a side of the pixelated lighting device which is closest to the wall or floor. The side farthest from the wall or floor and the side closest to the wall or floor are determined based on the position determined in step 171. First, it may be determined whether the pixelated lighting device is closest to the wall or floor and then the side farthest from this surface and the side closest to this surface may be determined. The processor may receive data indicative of the position of the pixelated lighting device relative to the wall or floor via the input interface. The data may for example be a user input, or a sensor input.

Aspects described in relation to one of the above embodiments can normally also be used in another one of the above embodiments. One or more of the embodiments of FIGS. 4-5 and 9-10 may be combined. For example, the embodiments of FIGS. 9 and 10 may be combined. Similar extensions as made to the embodiment of FIG. 5 in order to obtain the embodiment of FIG. 9 and/or the embodiment of FIG. 10 may be made to the embodiment of FIG. 4.

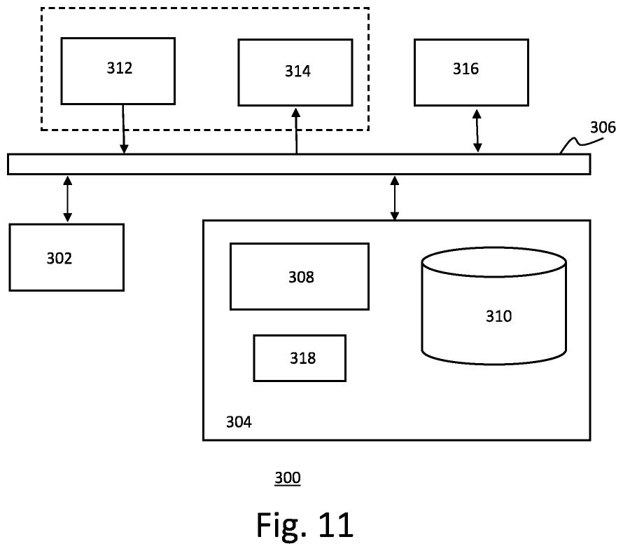

FIG. 11 depicts a block diagram illustrating an exemplary data processing system that may perform the method as described with reference to FIGS. 4-5 and 9-10.

As shown in FIG. 11, the data processing system 300 may include at least one processor 302 coupled to memory elements 304 through a system bus 306. As such, the data processing system may store program code within memory elements 304. Further, the processor 302 may execute the program code accessed from the memory elements 304 via a system bus 306. In one aspect, the data processing system may be implemented as a computer that is suitable for storing and/or executing program code. It should be appreciated, however, that the data processing system 300 may be implemented in the form of any system including a processor and a memory that is capable of performing the functions described within this specification.

The memory elements 304 may include one or more physical memory devices such as, for example, local memory 308 and one or more bulk storage devices 310. The local memory may refer to random access memory or other non-persistent memory device(s) generally used during actual execution of the program code. A bulk storage device may be implemented as a hard drive or other persistent data storage device. The processing system 300 may also include one or more cache memories (not shown) that provide temporary storage of at least some program code in order to reduce the quantity of times program code must be retrieved from the bulk storage device 310 during execution. The processing system 300 may also be able to use memory elements of another processing system, e.g. if the processing system 300 is part of a cloud-computing platform.

Input/output (I/O) devices depicted as an input device 312 and an output device 314 optionally can be coupled to the data processing system. Examples of input devices may include, but are not limited to, a keyboard, a pointing device such as a mouse, a microphone (e.g. for voice and/or speech recognition), or the like. Examples of output devices may include, but are not limited to, a monitor or a display, speakers, or the like. Input and/or output devices may be coupled to the data processing system either directly or through intervening I/O controllers.

In an embodiment, the input and the output devices may be implemented as a combined input/output device (illustrated in FIG. 11 with a dashed line surrounding the input device 312 and the output device 314). An example of such a combined device is a touch sensitive display, also sometimes referred to as a “touch screen display” or simply “touch screen”. In such an embodiment, input to the device may be provided by a movement of a physical object, such as e.g. a stylus or a finger of a user, on or near the touch screen display.

A network adapter 316 may also be coupled to the data processing system to enable it to become coupled to other systems, computer systems, remote network devices, and/or remote storage devices through intervening private or public networks. The network adapter may comprise a data receiver for receiving data that is transmitted by said systems, devices and/or networks to the data processing system 300, and a data transmitter for transmitting data from the data processing system 300 to said systems, devices and/or networks. Modems, cable modems, and Ethernet cards are examples of different types of network adapter that may be used with the data processing system 300.

As pictured in FIG. 11, the memory elements 304 may store an application 318. In various embodiments, the application 318 may be stored in the local memory 308, the one or more bulk storage devices 310, or separate from the local memory and the bulk storage devices. It should be appreciated that the data processing system 300 may further execute an operating system (not shown in FIG. 11) that can facilitate execution of the application 318. The application 318, being implemented in the form of executable program code, can be executed by the data processing system 300, e.g., by the processor 302. Responsive to executing the application, the data processing system 300 may be configured to perform one or more operations or method steps described herein.

FIG. 11 shows the input device 312 and the output device 314 as being separate from the network adapter 316. However, additionally or alternatively, input may be received via the network adapter 316 and output be transmitted via the network adapter 316. For example, the data processing system 300 may be a cloud server. In this case, the input may be received from and the output may be transmitted to a user device that acts as a terminal.

Various embodiments of the invention may be implemented as a program product for use with a computer system, where the program(s) of the program product define functions of the embodiments (including the methods described herein). In one embodiment, the program(s) can be contained on a variety of non-transitory computer-readable storage media, where, as used herein, the expression “non-transitory computer readable storage media” comprises all computer-readable media, with the sole exception being a transitory, propagating signal. In another embodiment, the program(s) can be contained on a variety of transitory computer-readable storage media. Illustrative computer-readable storage media include, but are not limited to: (i) non-writable storage media (e.g., read-only memory devices within a computer such as CD-ROM disks readable by a CD-ROM drive, ROM chips or any type of solid-state non-volatile semiconductor memory) on which information is permanently stored; and (ii) writable storage media (e.g., flash memory, floppy disks within a diskette drive or hard-disk drive or any type of solid-state random-access semiconductor memory) on which alterable information is stored. The computer program may be run on the processor 302 described herein.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of embodiments of the present invention has been presented for purposes of illustration, but is not intended to be exhaustive or limited to the implementations in the form disclosed. Many modifications and variations will be apparent to those of ordinary skill in the art without departing from the scope and spirit of the present invention. The embodiments were chosen and described in order to best explain the principles and some practical applications of the present invention, and to enable others of ordinary skill in the art to understand the present invention for various embodiments with various modifications as are suited to the particular use contemplated.

1. A system for controlling a plurality of individually controllable light segments of a pixelated lighting device to render a first light scene and subsequently a second light scene, said system comprising:
at least one input interface;
at least one control interface; and
at least one processor configured to:
obtain data indicative of an orientation and/or a shape of said pixelated lighting device,
control, via said at least one control interface, said plurality of individually controllable light segments to render said first light scene,
receive, via said at least one input interface input, indicative of activation of said second light scene,
select a type of transition based on said orientation and/or said shape, a first type of transition being selected for a first orientation or a first shape and a second type of transition being selected for a second orientation or a second shape,
determine a transition from said first light scene to said second light scene based on said selected type of transition,
control, via said at least one control interface said plurality of individually controllable light segments to render said transition, and
control, via said at least one control interface, said plurality of individually controllable light segments to render said second light scene.

2. A system as claimed in claim 1, wherein said input is user input.

3. A system as claimed in claim 1, wherein said first type of transition and said second type of transition are different spatial transitions.

4. A system as claimed in claim 3, wherein light settings from said first light scene are shifted towards a first side of said pixelated lighting device and light settings from said second light scene are moved in at a second side of said pixelated lighting device.

5. A system as claimed in claim 3, wherein light settings from said first light scene are shifted towards sides of said pixelated lighting device and light settings from said second light scene are moved in at a center of said pixelated lighting device or wherein light settings from said first light scene are shifted towards a center of said pixelated lighting device and light settings from said second light scene are moved in at sides of said pixelated lighting device.

6. A system as claimed in claim 1, wherein said at least one processor is configured to select said type of transition based on said orientation of said pixelated lighting device and based on a desired spatial transition direction or an orientation of a further pixelated lighting device.

7. A system as claimed in claim 1, wherein said at least one processor is configured to select said type of transition further based on a position of said pixelated lighting device

8. A system as claimed in claim 7, wherein said orientation of said pixelated lighting device is vertical and said selected transition comprises moving out light settings from said first light scene at a side of said pixelated lighting device which is farthest from a wall or floor and moving in light settings from said second light scene at a side of said pixelated lighting device which is closest to said wall or floor,
wherein the processor is configured to determine said side farthest from the wall or floor and said side closest to the wall or floor based on said position.

9. A system as claimed in claim 1, wherein said first shape is a circle and said second shape is a line.

10. A system as claimed in claim 1, wherein said first light scene and said second light scene define color and/or brightness gradients.

11. A system as claimed in claim 1, wherein said at least one processor is configured to select said type of transition further based on a user preference.

12. A system as claimed in claim 1, wherein said second light scene is independent of said first light scene.

13. A method of controlling a plurality of individually controllable light segments of a pixelated lighting device to render a first light scene and subsequently a second light scene, said method comprising:
obtaining data indicative of an orientation and/or a shape of said pixelated lighting device;
controlling said plurality of individually controllable light segments to render said first light scene;
receiving input indicative of activation of said second light scene;
selecting a type of transition based on said orientation and/or said shape, a first type of transition being selected for a first orientation or a first shape and a second type of transition being selected for a second orientation or a second shape;
determining a transition from said first light scene to said second light scene based on said selected type of transition;
controlling said plurality of individually controllable light segments to render said transition; and
controlling said plurality of individually controllable light segments to render said second light scene.

14. A computer program product for a computing device, the computer program product comprising computer program code to perform the method of claim 13 when the computer program product is run on a processing unit of the computing device.
